(19) United States
(12) Patent Application Publication
(10) Pub. No.: US 2006/0037629 A1
(43) Pub. Date: Feb. 23, 2006

(54) Methods and systems for supplying deionized water in a wet station

(76) Inventor: Min-Soo Roh, Eumseong-gun (KR)

Correspondence Address: HANLEY, FLIGHT & ZIMMERMAN, LLC, 20 N. WACKER DRIVE, SUITE 4220, CHICAGO, IL, 60606, US

(21) Appl. No.: 11/205,417

(22) Filed: Aug. 17, 2005

(30) Foreign Application Priority Data
Aug. 19, 2004 (KR) 10-2004-0065485

(51) Int. Cl. B08B 3/00

(52) U.S. Cl. 134/34; 134/56 R; 134/902

(57) ABSTRACT

Systems and methods for supplying deionized water to a rinse bath of a wet station are disclosed An example system includes a deionized water line to supply the deionized water to a rinse bath for cleaning a wafer, a valve in communication with the deionized water line and having a plurality of open modes in which different amounts of deionized water are supplied and a closed mode in which the supply of the deionized water is shut off, and a controller to select the operating mode of the valve.

### FIELD OF THE DISCLOSURE

The present disclosure relates generally to semiconductor manufacturing, and, more particularly, to systems and methods for supplying deionized water to a rinse bath of a wet station for cleaning of wafers, etching of an oxide layer, etc.

### BACKGROUND

In a typical process of manufacturing a semiconductor device, a thin film is deposited on a semiconductor wafer, and then a photosensitive material is applied to form the deposited thin film into a desired pattern. The applied photosensitive material is then exposed through a pattern mask and is then etched using chemicals. Thereafter, the remaining photosensitive material is then removed to obtain the desired pattern. Such a patterning process involves a post-process such as cleaning, rinsing, and drying to remove foreign particles remaining on the wafer after the etching process is completed.

A wet station is an apparatus for performing post-processes such as etching, rinsing, drying, etc. Generally, the wet station includes a loader for moving a wafer carrier loaded with a plurality of wafers to a working position. It also includes a plurality of baths for etching and cleaning, a spin dryer for drying the wafer, and an unloader for moving the processed wafer carrier. The baths may include a chemical bath, a rinse bath, etc.

The rinse bath is an apparatus for cleaning the wafer with deionized water. Deionized water is supplied to the rinse bath through a deionized water line. An air valve is provided in the deionized water line.

A shut-off valve may be used for the air valve such that the deionized water may be supplied to the rinse bath while the wafer is cleaned therein, and it is shut off in ordinary circumstances.

In this patent, the shut-off state of the air valve is called a closed mode and an open state of the air valve is called an open mode.

However, in a system supplying deionized water having the above-described structure, the air valve is operated in only the two operation modes, namely, in the open mode and the closed mode, because a shut off valve is used as the air valve. Accordingly, the amount of supplied deionized water cannot be controlled under the open mode, and a substantial amount of deionized water overflows. Therefore deionized water used in the bath and, accordingly, wastewater becomes excessively wasted.

### BRIEF DESCRIPTION OF THE DRAWINGS

FIG. 1 is a schematic illustration of an example system for supplying deionized water constructed in accordance with the teachings of the present invention.

FIG. 2 is a flowchart illustrating an example method for supplying deionized water using the example system shown in FIG. 1.

FIG. 3 is a schematic illustration of another example system for supplying deionized water constructed in accordance with the teachings of the present invention.

### DETAILED DESCRIPTION

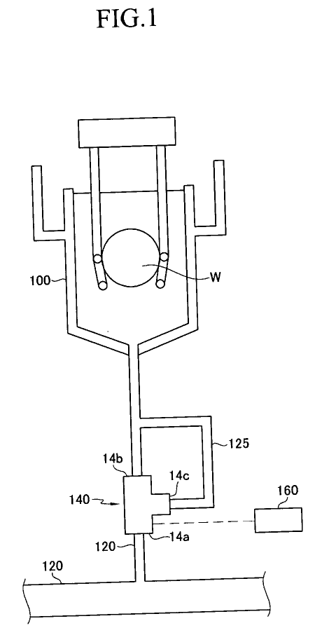

An example wet station constructed in accordance with the teachings of the invention is shown in FIG. 1. The example wet station of FIG. 1 includes a loader for moving a wafer carrier loaded with a plurality of wafers to a working position, a plurality of baths for etching and/or cleaning, a spin dryer for drying the wafers, and an unloader for moving the processed wafer carrier.

Although for simplicity of illustration, only an example rinse bath is shown in FIG. 1, persons of ordinary skill in the art will readily appreciate that the plurality of baths may include one or more chemical bath(s), one or more rinse bath(s), and/or any other type or number of bath(s) for performing, for example, one or more semiconductor fabrication process(es).

In the illustrated example, a deionized water line 120 is connected to a rinse bath 100 in which the wafer is cleaned using deionized water.

In the example of FIG. 1, an example system for supplying deionized water is located in the deionized water line 120 that is connected to the rinse bath 100. In the illustrated example, the system has a 3-way valve 140 having one intake port 14a and two exhaust ports 14b and 14c.

the example exhaust ports 14b and 14c of FIG. 1 have different diameters. Specifically, the diameter of the first exhaust port 14b connected to the deionized line 120 is larger than the diameter of the second exhaust port 14c connected to the bypass line 125.

In the illustrated example, the 3-way valve 140 having the above-described structure is operated under a closed mode (in which the first and second exhaust ports 14b and 14c are shut off), a first open mode (in which the intake valve 14a and the first exhaust valve communicate with each other), and a second open mode (in which the intake port 14a and the second exhaust port 14c communicate with each other). The operation of the valve 140 is controlled by a controller 160.

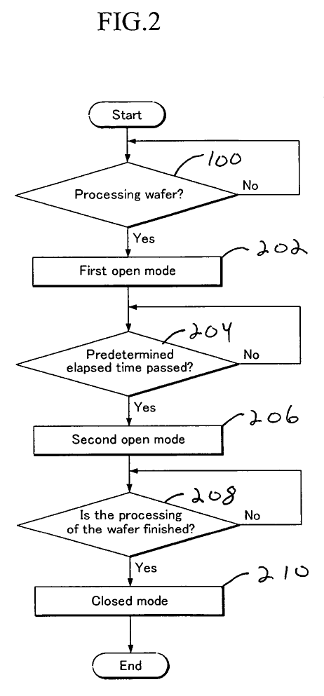

An example method for supplying deionized water using the example system described above will now be described with reference to FIG. 2.

First, a controller 160 determines whether there is a wafer to be processed by checking for existence of a wafer to be supplied to the rinse bath 100 (block 200). The controller 160 may determined that there is a wafer to be processed based on whether, for example, the wafer has already been supplied to the rinse bath 100.

When there is a wafer to be processed (block 200), the controller 160 opens the 3-way valve 140 to thereby initiate the first open mode. (block 202) The intake port 14a and the first exhaust port 14b thus begin to communicate with each other. The controller 160 maintains the first open mode of the valve part for a predetermined time, for example 60 seconds or 120 seconds. During this time, deionized water is supplied through the first exhaust port 14b at a rate of approximately 40 liters per minute.

After the predetermined time has elapsed (block 204), the controller 160 operates the 3-way valve 140 in the second open mode (block 206). Therefore, the intake port 14a and the second exhaust port 14c communicate with each other. As a result, deionized water received through the intake port 14a is supplied to the rinse bath 100 through the exhaust port 14c. Since the second exhaust port 14c has a smaller diameter than the first exhaust port 14b, a smaller amount of deionized water is supplied to the rinse bath under the second open mode than under the first open mode. In the illustrated example, deionized water is supplied through the second exhaust port 14c at a rate of about 30 liters per minute during the second open mode.

Then, when the processing of the wafer is finished (block 208), the controller 160 closes the first and second exhaust ports 14b and 14c, thereby changing the 3-way valve 140 into the closed mode. Therefore, the supply of deionized water to the rinse bath is shut off.

In the above described example, a large amount of deionized water is supplied through the first exhaust port 14b of the 3-way valve 140 at the beginning stage of the wafer cleaning treatment. Then, after a predetermined time has elapsed, the deionized water is supplied through the second exhaust valve 14c at a reduced flow rate. Therefore, a waste of deionized water and resultant wastewater is reduced relative to the prior art.

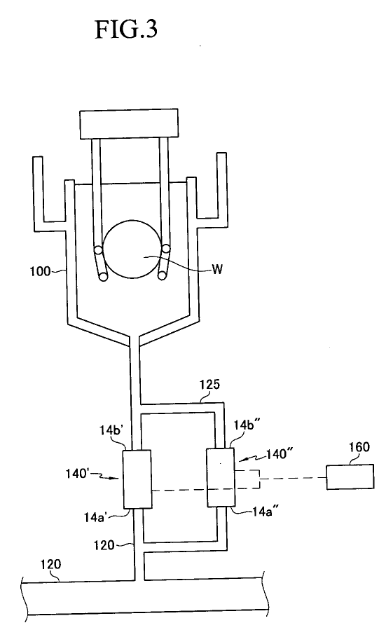

FIG. 3 is a schematic illustration of another example system for supplying deionized water constructed in accordance with the teachings of the present invention. The example system of FIG. 3 is different from the example system of FIG. 1 in that the example system of FIG. 3 includes two 2-way valves 140′ and 140″. The valves 140′, 140″ respectively have intake ports 14a′ and 14a″ and exhaust ports 14b′ and 14b″ which are respectively connected to the intake ports 14a′ and 14a″ as shown in FIG. 3.

In the illustrated example, the air valve 140′, disposed in the deionized water line 120 is structured to supply the deionized water at the same rate as the first exhaust port 14b of the 3-way valve 140. In the example of FIG. 3, an air valve 140,″ which is disposed in the bypass line 125, is structured to supply the deionized water at the same rate as the second exhaust port 14c of the 3-way valve 140.

At the beginning stage of cleaning the wafer, the deionized water is supplied to the bath 100 via a first open mode (that is, the deionized water is supplied to the bath 100 through the air valve 140′ disposed in the deionized water line 120), and then, after a predetermined time (for example, approximately 60 seconds-120 seconds), the deionized water is supplied to the bath 100 via a second open mode (that is, the deionized water is supplied to the bath 100 through the air valve 140″ disposed in the bypass line 125).

When the processing of the wafer is finished, the two air valves 140′ and 140″ are shut off to thereby stop the supply of the deionized water to the rinse bath 100.

In the illustrated example, at a beginning stage of cleaning a wafer, a large amount of deionized water is supplied. Then, after a predetermined time period, the amount of supplied deionized water is reduced. Therefore, the amount of deionized water used, and the resultant wastewater, is reduced.

From the foregoing, persons of ordinary skill in the art will readily appreciate that systems and methods for supplying deionized water to a rinse bath have been disclosed which reduce the amount of deionized water used and the wastewater produced by employing a valve in at least two operation modes.

A disclosed example deionized water supplying system for a wet station for performing a post-process such as etching, cleaning, drying, etc., includes a deionized water line supplying deionized water to a rinse bath for cleaning a wafer, a valve having at least two open modes in which different amounts of deionized water are supplied and a closed mode in which the supply of deionized water is shut off, and a controller to select the operation modes of the valve disposed in a deionized water line.

An illustrated valve part has first and second open modes. In that example, an amount of deionized water supplied in the second open mode is less than an amount of deionized water supplied in the first open mode.

In an illustrated example, the valve is a 3-way valve having an intake port and two exhaust ports. The intake port is connected to the two exhaust ports, and the two exhaust ports have different diameters from one another.

In other examples, the valve includes two, 2-way valves, each having an intake port and an exhaust port, respectively.

In a disclosed example method for supplying deionized water, a wet station controls a valve disposed in a deionized water line and supplies the deionized water to a rinse bath. In the disclosed method, it is determined whether treatment of a wafer is to be performed. The valve has at least two open modes for cleaning a wafer. Different amounts of deionized water are supplied in the different open modes. It is next determined whether the treatment of the wafer is completed or not. When completed, the supply of the deionized water is shut off by switching the valve into the closed mode.

In the illustrated example, when the deionized water is supplied to the rinse bath, a predetermined flow rate of deionized water is supplied to the rinse bath by operating the valve in the first open mode for a predetermined time measured from the time at which cleaning of the wafer is initiated. The elapsed time is monitored, and, after the predetermined time has elapsed, a reduced amount of deionized water is supplied to the rinse bath by changing the operation mode of the valve from the first open mode to the second open mode.

It is noted that this patent claims priority from Korean Patent Application Serial Number 10-2004-0065485, which was filed on Aug. 19, 2004, and is hereby incorporated by reference in its entirety.

Although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

What is claimed is:

1. For use in a wet station for performing post-processing a semiconductor device, a system for supplying deionized water, comprising:
a deionized water line to supply the deionized water to a rinse bath;
a valve in communication with the deionized water line and having first and second open modes and a closed mode, wherein a different amount of deionized water is supplied by the valve in the first open mode than in the second open mode, and wherein the supply of the deionized water is shut off in the closed mode; and
a controller to select the mode of the valve.

2. A system as defined in claim 1, wherein the valve is switched between the first and second open modes during processing of a wafer.

3. A system as defined in claim 2, wherein the amount of deionized water supplied in the second open mode is less than the amount of deionized water supplied in the first open mode.

4. A system as defined in claim 2, wherein the valve comprises a 3-way valve having an intake port and at least two exhaust ports, the intake port is in selective communication with each of the exhaust ports, and the each of the exhaust ports has a different diameter.

5. A system as defined in claim 3, wherein the valve comprises a 3-way valve having an intake port and at least two exhaust ports, the intake port is connected to the exhaust ports, and the exhaust ports have different diameters.

6. A system as defined in claim 2, wherein the valve comprises at least two, 2-way valves, each of the 2-way valves having an intake port and an exhaust port.

7. A system as defined in claim 3, wherein the valve comprises at least two, 2-way valves, each of the 2-way valves having an intake port and an exhaust port.

8. A method for supplying deionized water in a wet station by controlling a valve in which is coupled to a deionized water line and which supplies deionized water to a rinse bath, comprising:
determining whether a wafer is to be processed;
switching the valve between a first open mode and a second open mode to supply deionized water;
determining whether processing of the wafer is completed; and
switching the vale into a closed mode to shut off the supply of the deionized water.

9. A method for supplying deionized water as defined in claim 8, wherein switching the valve between the first open mode and the second open mode comprises:
supplying the deionized water at a first rate for a predetermined time when the valve is in the first open mode, the predetermined time beginning when cleaning the wafer is initiated;
monitoring an elapsed time; and
after the predetermined time has elapsed, supplying the deionized water at a second rate which is smaller than the first rate when the valve is in the second open mode.
